(19) United States
(12) Patent Application Publication
(10) Pub. No.: US 2008/0198962 A1
(43) Pub. Date: Aug. 21, 2008

(54) Device for measuring size of steel bar in structure and method thereof

(75) Inventors: Chung-Yue Wang, Taipei City (TW); Peng-Ching Peng, Jhonghe City (TW)

Correspondence Address: TROXELL LAW OFFICE PLLC, 5205 LEESBURG PIKE, SUITE 1404, FALLS CHURCH, VA, 22041, US

(73) Assignee: National Central University, Taoyuan County (TW)

(21) Appl. No.: 11/723,205

(22) Filed: Mar. 16, 2007

(30) Foreign Application Priority Data
Feb. 15, 2007 (TW) 096105808

(51) Int. Cl. G01N 23/04

(52) U.S. Cl. 378/1

(57) ABSTRACT

A gamma ray, an X-ray or an ionizing irradiation penetrates through a steel bar in a reinforced concrete structure. An image of the steel bar is thus projected on a film. Through geometric relationships between the image and the steel bar itself, the size of the steel bar is calculated. The size of the steel bar obtained according to the present invention is reliable and accurate. And the data obtained can be used for structure safety.

### FIELD OF THE INVENTION

The present invention relates to measuring a steel bar size; more particularly, relates to computing a size of a steel bar in a structure with improved reliability and accuracy as a reference for a structure safety.

### DESCRIPTION OF THE RELATED ARTS

To obtain structure safety, examining steel bar in structure with reliability and accuracy is more and more important. However, a reinforced concrete structure having steel bar is an uneven composite material of steel bar, concrete, sand, aggregate, water and admixture, so that examinations done by using stress waves or through electromagnetism principles still face some difficulties.

Concerning examining steel bar in a structure, electromagnetism principles are usually used; yet their accuracies are so affected by permeability, conductivity, steel bar interval and steel bar construction that difficulties and errancies in examinations increase.

For example, a steel bar detector using eddy current is developed. A detector having an alternating wire coil is located near a detected steel bar protecting layer to produce a number of eddy-like currents through electromagnetic induction at an alternating magnetic field of the steel bar. And, by the changes in signals of eddy currents, a position and a size of the steel bar are detected. Yet, in places having multiple steel bars or jointing steel bar, interferences to electromagnetic induction occur with the neighboring steel bars and so detection using electromagnetic induction would fail. Thus, a structure safety is not ensured. Hence, the prior arts do not fulfill users' requests on actual use.

### SUMMARY OF THE INVENTION

The main purpose of the present invention is to irradiating a gamma ray by a radiation source to project an image of a steel bar, whose position in a structure is acquired in advance, on an imaging device for computing a size of the steel bar through geometric relationships between the image of the steel bar and the steel bar itself.

Another purpose of the present invention is to compute the size of the steel bar with improved reliability and accuracy as a reference for a structure safety

To achieve the above purposes, the present invention is a device for measuring a size of a steel bar in a structure and a method thereof, comprising a radiation source, an imaging device and a computing module, where, through a gamma ray irradiated from the radiation source, a steel bar in a structure, whose position is obtained in advance, has its image projected on the imaging device; and a size of the steel bar is thus computed through geometric relationships between the image of the steel bar and the steel bar itself with improved reliability and accuracy as a reference for a structure safety. Accordingly, a novel device for measuring a size of a steel bar in a structure and a method thereof are obtained.

### BRIEF DESCRIPTION OF THE DRAWING

The present invention will be better understood from the following detailed description of the preferred embodiment according to the present invention, taken in conjunction with the accompanying drawing, in which

FIG. 1 is the flow view showing the preferred embodiment according to the present invention.

### DESCRIPTION OF THE PREFERRED EMBODIMENT

The following description of the preferred embodiment is provided to understand the features and the structures of the present invention.

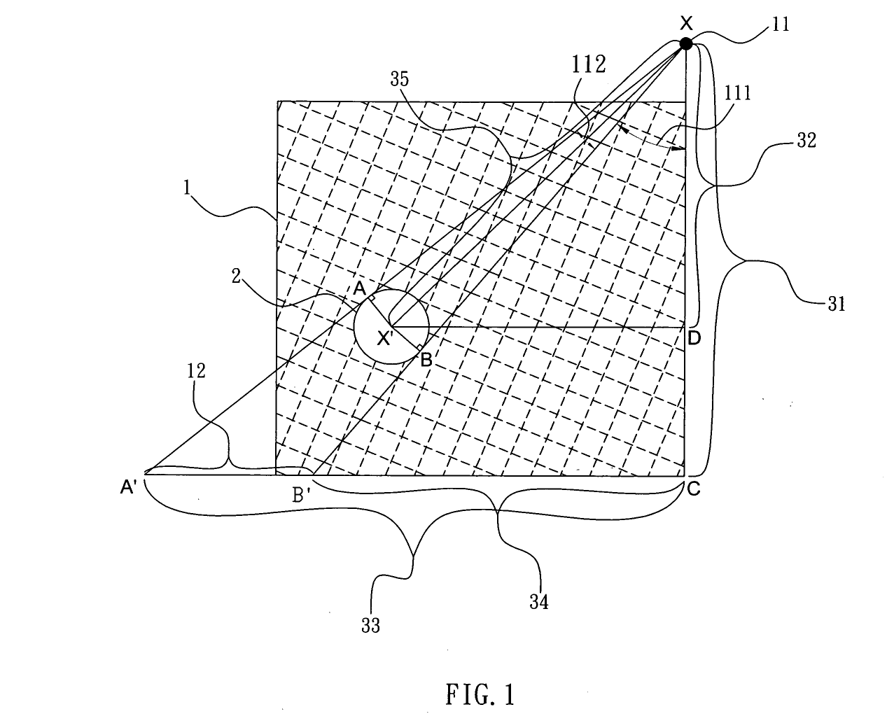

Please refer to FIG.1, which is a flow view showing a preferred embodiment according to the present invention. As shown in the figure, the present invention is a device for measuring a size of a steel bar in a structure and a method thereof. The device for measuring a size of a steel bar in a structure comprises a radiation source 11, an imaging device 12 and a computing module (not shown in the figure), where a size of a steel bar 2, whose position in a reinforced concrete structure 1 is acquired in advance, is computed with improved reliability and accuracy as a reference for a structure safety.

The radiation source 11 is located outside of the reinforced concrete structure and is a gamma ray, an X-ray or an ionizing radiation source The imaging device 12 is adhered to a horizontal surface of the reinforced concrete structure 1; and is located at a place corresponding to the radiation source 11 to receive a projected image of the steel bar by using the radiation source 11. The imaging device 12 is a film; or a sensor, which is further connected to a display to display the projected image of the steel bar with location data.

On using the present invention, the radiation source 11 is deposed outside of the reinforced concrete structure 1. A gamma ray is irradiated by the radiation source 11 to project an image of the steel bar 2 on the imaging device 12. And, through geometric relationships between the image of the steel bar 2 and the steel bar 2 itself, the size of the steel bar 2 is computed.

Thus, the computing module computes the steel bar size through the following steps:

(a) Locations of points are obtained, including a point of the radiation source 11 (X); a point (C) on the horizontal surface of the reinforced concrete structure 1; and a first edge point (B′) together with a second edge point (A′) on edge of the image of the steel bar 2 projected on the imaging device 12, where the X point is perpendicular to the C point on the horizontal surface of the reinforced concrete structure 1 the X point, the B′ point and the A′ point are on the same line; the B′ point is at the same side as the X point; and, the A′ point is a corresponding point to the B′ point at the other side of the image of the steel bar 2.

(b) A center of the steel bar 2 (X′) is perpendicular to a point (D) on a line segment (XC) 32 between the X point and the C point; and a length of a line segment (XD) 31 between the X point and the D point is pre-obtained. With the pre-obtained length of the XD line segment 31, lengths of line segments are measured, including a length of the XC line segment 32; a length of a line segment 33 (B′C) between the B′ point and the C point; and a length of a line segment 34 (A′C) between the A′ point and the C point.

(c) In a triangle having vertex points of X, C and A′,

$$tan ( {θ}_{1} + {θ}_{2} ) = \frac{{A}^{′} C}{XC} .$$

Therein, a first angle 111 (θ₁) together with a second angle 112 (θ₂) has a tangent value equivalent to the length of the A′C line segment 34 divided by the length of the XC line segment 32. The value of the θ₁ angle 111 together with the θ₂ angle 111 (θ₁+θ₂) is thus computed through the tangent function, where the θ₁ angle 111 has an angle side of the XC line segment 32 and the other angle side of a line segment (XB′) between the X point and the B′ point; and where the second angle 112 has an angle side of the XB′ line segment and the other angle side of a line segment (XA′ ) between the X point and the A′ point.

(d) In a triangle having vertex points of X, C and B′,

$$tan ( {θ}_{1} ) = \frac{{CB}^{′}}{XC} .$$

Therein, the θ₁ angle 111 has a tangent value equivalent to the length of the B′C line segment 33 divided by the length of the XC line segment 32. The value of the θ₁ angle 111 is thus computed through the tangent function; and a value of the θ₂ angle 112 is obtained by deducting the value of the θ₁ angle 111 from the value of the θ₁+θ₂ angle 111+112.

(e ) In a triangle having vertex points of X, D and X′,

$$cos ( {θ}_{1} + \frac{{θ}_{2}}{2} ) = \frac{XD}{{XX}^{′}} .$$

Therein, the θ₁ angle 111 together with an abiding half of the θ₂ angle 112

$$( {θ}_{1} + \frac{{θ}_{2}}{2} )$$

has a cosine value equivalent to the length of the XD line segment 32 divided by a length of a line segment 35 (XX′) between the X point and the X′ point. The length of the XX′ line segment 35 is thus computed through the cosine function.

(f) And, in a triangle having vertex points of X, A and X′,

$$sin ( \frac{{θ}_{2}}{2} ) = \frac{{X}^{′} A}{{XX}^{′}} .$$

Therein, a point (A) on the XA′ line segment is perpendicularly corresponding to the X′ point; and, the other half of the θ₂ angle

$$112 ( \frac{{θ}_{2}}{2} )$$

has a sine value equivalent to a length of a line segment between the X′ point and the A point divided by the length of the XX′ line segment. A length of the X′A line segment, a semi-diameter of the steel bar 2, is thus computed through the sine function. Accordingly, a size of the steel bar 2 is obtained by doubling the length of the X′A line segment.

To sum up, the present invention is a device for measuring a size of a steel bar in a structure and a method thereof, where a size of a steel bar, whose position in a structure is acquired in advance, is computed with improved reliability and accuracy as a reference for a structure safety.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention

What is claimed is:

1. A device for measuring a size of a steel bar in a structure, comprising:
a structure, said structure having a steel bar;
a radiation source, said radiation source being located at outside of said structure to irradiate said structure;
a imaging device, said imaging device being deposed on a horizontal surface of said structure corresponding to said radiation source, an image of said steel bar in said structure being projected on said imaging device by using said radiation source; and
a computing module, said computing module computing a size of said steel bar in said structure through geometric relationships between said image of said steel bar and said steel bar itself.

2. The device according to claim 1,
wherein said structure is a structure of a reinforced concrete structure.

3. The device according to claim 1,
wherein said radiation source is a gamma ray radiation source.

4. The device according to claim 1,
wherein said radiation source is an X-ray radiation source.

5. The device according to claim 1,
wherein said radiation source is an ionizing radiation source.

6. The device according to claim 1
wherein said imaging device is a film to display said projected image of said steel bar.

7. The device according to claim 1
wherein said imaging device is a sensor to display said projected image of said steel bar.

8. The device according to claim 7,
wherein said sensor is further connected to a display to display said projected image of said steel bar with position data.

9. The device according to claim 1
wherein said device has a method for measuring a steel bar size, comprising steps of:
(a) obtaining:
a point (X) of said radiation source;
a point (C) on said horizontal surface of said reinforced concrete structure;
a point (D ) on a line segment (XC) between said X point and said C point; and
a first edge point (B′) together with a second edge point (A′) on edge of said image of said steel bar,
wherein said X point is perpendicular to said C point;
wherein a center point (X′) of said steel bar is perpendicular to said D point;
wherein said X point, said B′ point and said A′ point are on a line;
wherein said B′ point is at the same side as said X point;
wherein said A′ point is a corresponding point to said A point at the other side of the image of the steel bar;
(b) With a length of a line segment (XD) between said X point and said D point obtained in advance, obtaining:
a length of said XC line segment;
a length of a line segment (B′C) between said B′ point and said C point; and
a length of a line segment (A′C between said A′ point and said C point;
(c) obtaining a value of a first angle together with a second angle through a tangent function of said first angle together with said second angle,
wherein said first angle has an angle side of said XC line segment and the other angle side of a line segment (XB′) between said X point and said B′ point;
wherein said second angle has an angle side of said XB′ line segment and the other angle side of a line segment (XA′) between said X point and said A′ point; and
wherein said first angle together with said second angle is obtained though said tangent function whose value is equivalent to said length of said A′C line segment divided by said length of said XC line segment;
(d) obtaining a value of said first angle and a value of said second angle through a tangent function of said first angle,
wherein said value of said first angle is obtained through said tangent function whose value is equivalent to said length of said B′C line segment divided by said length of said XC line segment; and
wherein said value of said second angle is obtained by deducting said value of said first angle from said value of said first angle together with said second angle;
(e) obtaining a length of a line segment (XX′) between said X point and said X′ point through a cosine function of said first angle together with an abiding half of said second angle,
wherein said length of said XX′ line segment is obtained through said cosine function whose value is equivalent to said length of said XD line segment divided by said length of said XX′ line segment; and
(f) obtaining said steel bar size through a sine function of the other half of said second angle,
wherein a point (A) is on said XA′ line segment where said X′ point is perpendicular to said A point;
where in a length of a line segment (X′A) between said X′ point and said A point is obtained through said sine function whose value is equivalent to said length of said X′A line segment divided by said length of said XX′ line segment; and
wherein said steel bar size is obtained by doubling said length of said X′A line segment.
